(19) United States
(12) Patent Application Publication
(10) Pub. No.: US 2011/0291920 A1
(43) Pub. Date: Dec. 1, 2011

(54) ELECTRONIC BOOK

(75) Inventors: QIAN CHENG, Shenzhen City (CN); MING-CHANG LEE, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/823,300

(22) Filed: Jun. 25, 2010

(30) Foreign Application Priority Data
Jun. 1, 2010 (CN) 201010188660.9

(51) Int. Cl. G09G 3/34

(52) U.S. Cl. 345/107

(57) ABSTRACT

An electronic book includes a main body and a pivot member rotatably mounted to the main body. The main body includes an electrophoretic display, and defines a first receiving space in a bottom of the main body. The pivot member includes a base plate received in the first receiving space and a lighting body mounted to the base plate. When the electronic book is used, the pivot member is rotated relative to the main body, the base plate is moved out of the first receiving space to be positioned above the electrophoretic display, and then the lighting body is turned on to light the electrophoretic display.

### BACKGROUND

1. Technical Field

The present disclosure relates to an electronic book.

2. Description of Related Art

Due to small size, light weight, and ease of storage, electronic books are widely used. A conventional electronic book includes an electrophoretic display (EPD). However, the electrophoretic display is only visible when externally lit.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of an electronic book.

FIG. 2 shows a use view of the electronic book of FIG. 1.

FIG. 3 is an inverted view of the electronic book of FIG. 2.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

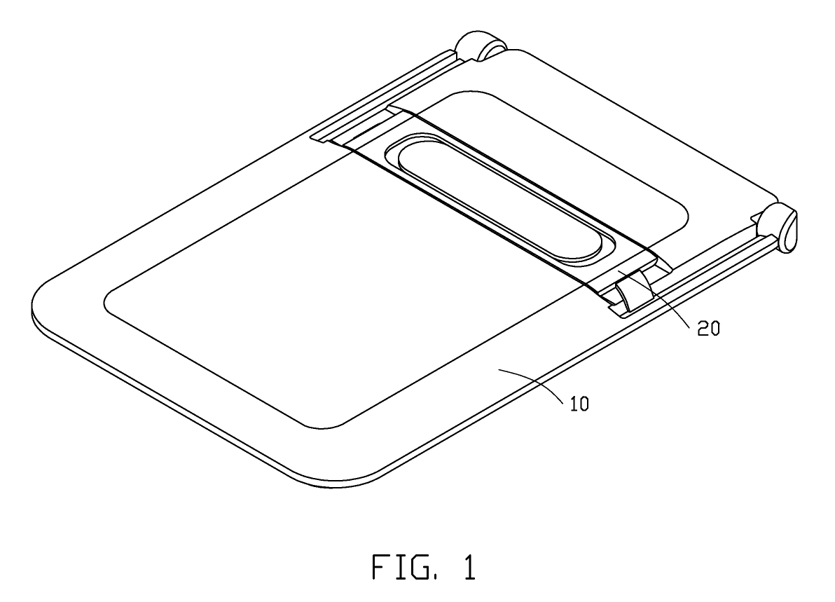

Referring to FIG. 1, an exemplary embodiment of an electronic book includes a main body 10 and a pivot member 20 rotatably mounted to the main body 10.

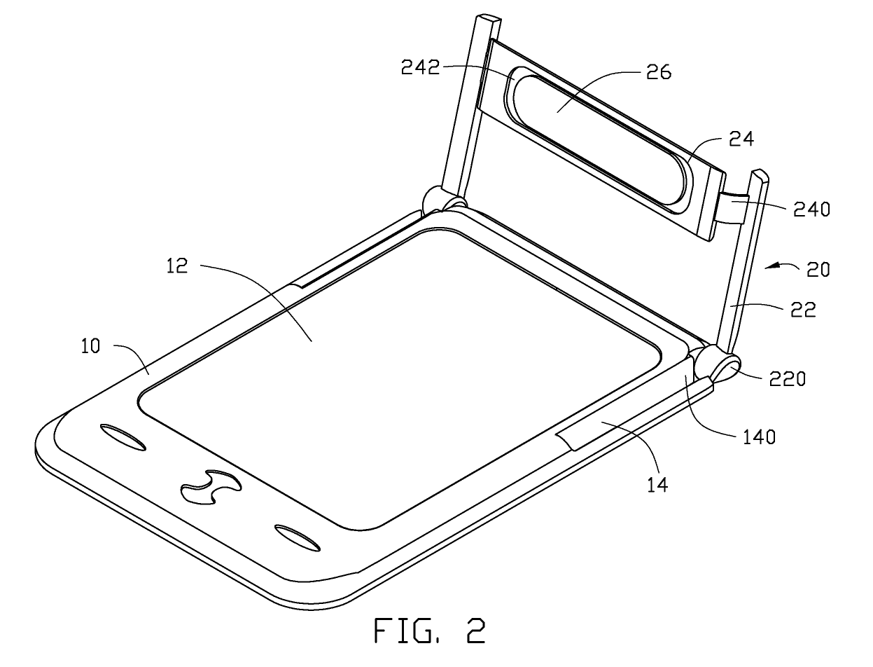

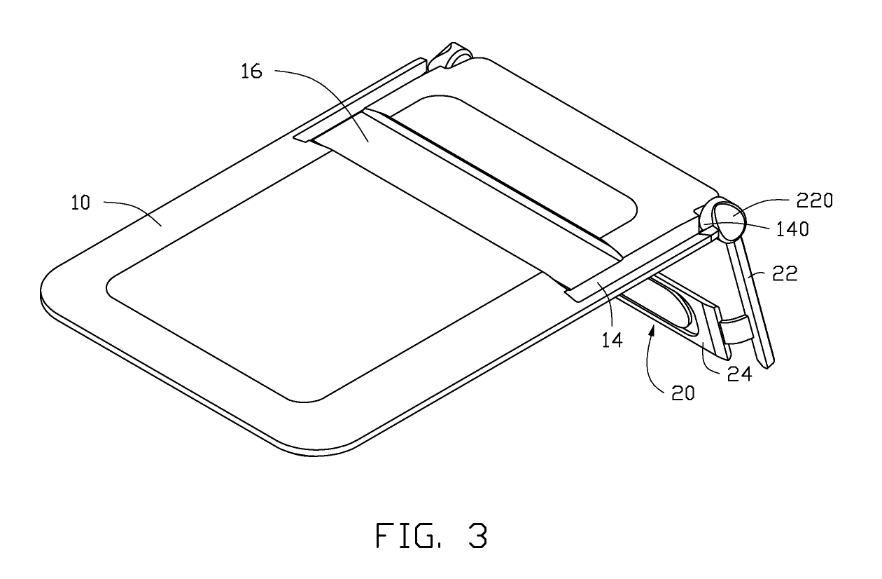

Referring to FIGS. 2 and 3, the main body 10 is as an ordinary electronic book and includes an electrophoretic display (EPD) 12. Opposite sides of the main body 10 define two rectangular through holes 14. Two avoiding openings 140 are defined in opposite sides of a top end of the main body 10. Each avoiding opening 140 is communicated with a corresponding one of the through holes 14. A bottom of the main body 10 opposite to the EPD 12 defines a receiving space 16, between the through holes 14.

The pivot member 20 includes two pivot rods 22, a base plate 24, and a lighting body 26 mounted on the base plate 24. Each pivot rod 22 includes a first end and an opposite second end. The second end of each pivot rod 22 forms a pivot portion 220. The pivot portions 220 of the pivot rods 22 are rotatably mounted to opposite sides of the top end of the main body 10. Each pivot portion 220 aligns with the corresponding avoiding opening 140.

Two arc-shaped tabs 240 extend from opposite ends of the base plate 24, to be connected to the first ends of the pivot rods 22, thereby the base plate 24 is mounded between the pivot rods 22. The base plate 24 defines a receiving space 242. The lighting body 26 is received in the receiving space 242 and electrically connected to electronic elements in the main body 10. The lighting body 26 is a surface light source and includes a plurality of light emitting diodes.

Referring to FIGS. 1, and 2, when the electronic book is used in darkness, the tabs 240 are operated to rotate the pivot member 20, relative to the main body 10, about the pivot portions 220. The base plate 24 can be rotated to a desired position where it can light the EPD 12, then the lighting body 26 is turned on to light the EPD 12.

When not in use, the pivot member 20 can be rotated back until the base plate 24 is received in the receiving space 16, and the pivot rods 22 are received in the through holes 14.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electronic book comprising:
a main body comprising an electrophoretic display, and defining a first receiving space in a bottom of the main body opposite to the electrophoretic display; and
a pivot member rotatably mounted to the main body, comprising a base plate and a lighting body mounted to the base plate, wherein the base plate is operable to be received in the first receiving space;
wherein when the electronic book is used, the pivot member is rotated relative to the main body, the base plate is moved out of the first receiving space to be positioned above the electrophoretic display, the lighting body is turned on to light the electrophoretic display.

2. The electronic book of claim 1, wherein the lighting body is a surface light source made of a plurality of light emitting diodes.

3. The electronic book of claim 1, wherein the pivot member further comprises two pivot rods, two tabs extend from opposite ends of the base plate to be connected to the pivot rods, to mount the base plate between first ends of the pivot rods.

4. The electronic book of claim 3, wherein each tab is arc-shaped.

5. The electronic book of claim 1, wherein opposite sides of the main body define two through holes to receive the corresponding pivot rods.

6. The electronic book of claim 5, wherein second ends of the two pivot rods opposite to the first ends form two pivot portions rotatably mounted to opposite sides of a top end of the main body.

7. The electronic book of claim 1, wherein the base plate defines a second receiving space to receive the lighting body.
